(19) United States
(12) Patent Application Publication
(10) Pub. No.: US 2012/0198503 A1
(43) Pub. Date: Aug. 2, 2012

(54) System and Method for Domestic Multimedia Playing

(75) Inventors: Chaoyang GU, Shenzhen (CN); Yubin Fan, Shenzhen (CN)

(73) Assignees: Diamondking Inc; Shenzhen GIEC Electronics Co., Ltd

(21) Appl. No.: 13/234,153

(22) Filed: Sep. 16, 2011

(30) Foreign Application Priority Data
Jan. 27, 2011 (CN) 201110029952.2

(51) Int. Cl. H04N 21/23

(52) U.S. Cl. 725/81

(57) ABSTRACT

The present invention relates to a system and method for domestic multimedia playing. The method comprises a transmitter receives audio and video data outputted by a plurality of multimedia devices; the transmitter analog-to-digital converts the audio and video data respectively; the transmitter encodes and compresses the converted audio and video data; the transmitter transmits the encoded and compressed audio and video data to a receiver by a means of 2.4G radio frequency; the receiver receives the audio and video data from the transmitter by a means of 2.4G radio frequency; the receiver decompresses and decodes the received audio and video data; the receiver digital-to-analog converts the decompressed and decoded audio and video data and drives a display screen and a power amplification module to play the converted audio and video data. When implementing present invention, the user can carry the receiver and watch multimedia program at any time and anywhere.

### FIELD OF THE INVENTION

The present invention relates to multimedia technique field, more particularly, to a system and method for domestic multimedia playing.

### BACKGROUND OF THE INVENTION

Domestic multimedia playing system has provided people convenient and comfortable live enjoyment. At present, multimedia playing system, such as TV, computer, DVD and so on, are generally fixed at one place, such as in the living room. User should stay at the living room and watch multimedia programs. Although notebook computers are getting smaller and smaller, it still can not be moved optionally and conveniently when playing multimedia programs.

### SUMMARY OF THE INVENTION

One aspect of present invention is to provide a system for multimedia playing enabling watching multimedia programs at anytime and anywhere, aiming at solving technical problem that multimedia playing system in prior art can not be moved optionally and conveniently.

Technical solution employed by present invention for solving its technical problem is constructing a system for domestic multimedia playing, which comprises a transmitter and a receiver, wherein,

the transmitter further comprises:

a multiplex audio and video interface coupled to a plurality of multimedia devices and operable to receive audio and video data outputted from the multimedia devices,

a video analog-to-digital conversion module operable to analog-to-digital convert received video data,

an audio analog-to-digital conversion module operable to analog-to-digital convert received audio data,

a first main control module operable to encode and compress the analog-to-digital converted audio and video data,

a first 2.4G transceiver module operable to transmit encoded and compressed audio and video data to the receiver;

the receiver further comprises:

a display screen,

a power amplification module,

a second 2.4G transceiver module operable to receive audio and video data from the transmitter,

a second main control module operable to decode and decompress the received audio and video data,

a process and display screen drive module operable to digital-to-analog convert the decoded and decompressed video data and drive the display screen to play the converted video;

an audio digital-to-analog conversion module operable to digital-to-analog convert the decoded and decompressed audio data and drive the power amplification module to play the converted audio.

Advantageously, the system for domestic multimedia playing further comprises a remote controller, wherein;

the receiver further comprises a remote control receiving head and a second infrared ray processor, wherein;

the remote control receiving head is operable to receive remote control signal sent from the remote controller;

the second infrared ray processor is operable to identify received remote control signal and transform the received remote control signal to corresponding binary code;

the second main control module is further operable to encode and compress the binary code;

the second 2.4G transceiver module is operable to transmit the encoded and compressed binary code to the transmitter;

the transmitter further comprises a first infrared ray processor and a infrared ray transmitting tube, and

the first 2.4G transceiver module is further operable to receive binary code from the receiver;

the first main controller is operable to decompress and decode the received binary code;

the first infrared ray processor is operable to transform the decompressed and decoded binary code to remote control signal;

the infrared ray transmitting tube is operable to transmit the remote control signal to corresponding multimedia devices.

Advantageously, the receiver comprises a panel key operable to receive input signals of the user; and

the process and display screen drive module is further operable to process the input signal; the second infrared ray processor is further operable to transform the processed input signal to corresponding binary code, and transmit the binary code to the second main control module, the binary code is the same as the binary code corresponding to the corresponding key of the remote controller.

Advantageously, the transmitter further comprises:

a storage module operable to store a plurality of remote controller code tables corresponding to the plurality of multimedia devices, and each remote controller code table is corresponding to type of one multimedia device.

Advantageously, when operating in a study mode, the remote controller is operable to receive a study signal of a key to be studied and transmit the study signals;

the remote control receiving head is further operable to receive the study signal;

the second infrared ray processor is operable to transform the study signal to corresponding binary code;

the second main control module is operable to encode and compress the binary code;

the second 2.4G transceiver module is operable to transmit the encoded and compressed binary code to the transmitter;

the first 2.4G transceiver module is operable to receive the binary code from the transmitter;

the first main control module is operable to decompress and decode the received binary code, and receive a signal from a key pressed by the user on the multimedia device and corresponded to the key to be studied, and to write the decompressed and decoded binary code into a new created remote controller code table in the storage module.

The present invention further constructs a method for domestic multimedia playing, which comprises:

a transmitter receives audio and video data outputted by a plurality of multimedia devices;

the transmitter analog-to-digital converts the audio and video data respectively;

the transmitter encodes and compresses the converted audio and video data;

the transmitter transmits the encoded and compressed audio and video data to a receiver by a means of 2.4G radio frequency;

the receiver receives the audio and video data from the transmitter by a means of 2.4G radio frequency;

the receiver decompresses and decodes the received audio and video data;

the receiver digital-to-analog converts the decompressed and decoded audio and video data and drives a display screen and a power amplification module to play the converted audio and video data.

Advantageously, when the remote controller operates in a remote control mode, the method for domestic multimedia playing further comprises:

the remote controller receives remote control signals inputted by the user and transmits the remote control signals by a mean of infrared ray;

the receiver identifies the remote control signals and transforms the remote control signals into corresponding binary code;

the receiver encodes and compresses the binary code;

the receiver transmits the encoded and compressed binary code to the transmitter by a means of 2.4G radio frequency;

the transmitter receives the binary code from the receiver by a means of 2.4G radio frequency;

the transmitter decompresses and decodes the received binary code; the transmitter transforms the decompressed and decoded binary code to corresponding remote control signal and transmits the remote control signal to corresponding multimedia devices.

Advantageously, when the remote controller operates in a study mode, the method for domestic multimedia playing further comprises:

the remote controller receives a study signal of a key to be studied and inputted by a user and transmits the study signals by a means of infrared ray;

the receiver identifies the study signal and transforms the study signal to corresponding binary code;

the receiver encodes and compresses the binary code;

the receiver transmits the encoded and compressed binary code to the transmitter by a means of 2.4G radio frequency;

the transmitter receives the binary code from the receiver by a means of 2.4G radio frequency;

the transmitter decompresses and decodes the received binary code;

the transmitter receives a signal from a key pressed by the user on the multimedia device and corresponded to the key to be studied, and writes the decompressed and decoded binary code into a new created remote controller code table.

Advantageously, when remote controlling the multimedia devices by using the remote controller, the method for domestic multimedia playing further comprises:

the transmitter determines whether the remote controller code table of the connected multimedia device is stored, if yes, the transmitter receives type of the connected multimedia device inputted by the user so as to match the keys of the remote controller and those of the multimedia device, or else, the transmitter operates in a study mode so as to match the keys of the remote controller and those of the multimedia device.

Advantageously, the method for domestic multimedia playing further comprises:

the panel key of the receiver receives input signal of the user;

the receiver transforms the received input signal to corresponding binary code, the binary code is the same as the binary code corresponding to the corresponding key of the remote controller;

the receiver encodes and compresses the binary code; the receiver transmits the encoded and compressed binary code to the

transmitter by a means of 2.4G radio frequency;

the transmitter receives the binary code from the receiver by a means of 2.4 G radio frequency;

the transmitter decompresses and decodes the received binary code;

the transmitter transforms the decompressed and decoded binary code to corresponding remote control signal and transmits the remote control signal to corresponding multimedia device.

When implementing technical solution of present invention, the transmitter and the multimedia device are connected together, and fixed at one place in the home, then the transmitter can transmits audio and video data of the multimedia device to the receiver by a means of 2.4G radio frequency and then the receiver receives and plays the audio and video. In such a way, the user can carry the receiver and watch multimedia program at any time and anywhere.

### BRIEF DESCRIPTION OF THE DRAWINGS

Hereinafter, embodiments of present invention will be described in detail with reference to the accompanying drawings, wherein:

FIG. 1A is a logic diagram of the first embodiment of the transmitter of the system for domestic multimedia playing according to present invention;

FIG. 1B is a logic diagram of the first embodiment of the receiver of the system for domestic multimedia playing according to present invention;

FIG. 2A is a logic diagram of the second embodiment of the transmitter of the system for domestic multimedia playing according to present invention;

FIG. 2B is a logic diagram of the second embodiment of the receiver of the system for domestic multimedia playing according to present invention;

FIG. 3 is a flow chart of the first embodiment of the method for domestic multimedia playing according to present invention;

FIG. 4 is a flow chart of the second embodiment of the method for domestic multimedia playing when the remote controller operates in a remote control mode according to present invention;

FIG. 5 is a flow chart of the third embodiment of the method for domestic multimedia playing when the remote controller operates in a study mode according to present invention.

### DETAILED DESCRIPTION OF THE PREFERRED EMBODIMENT

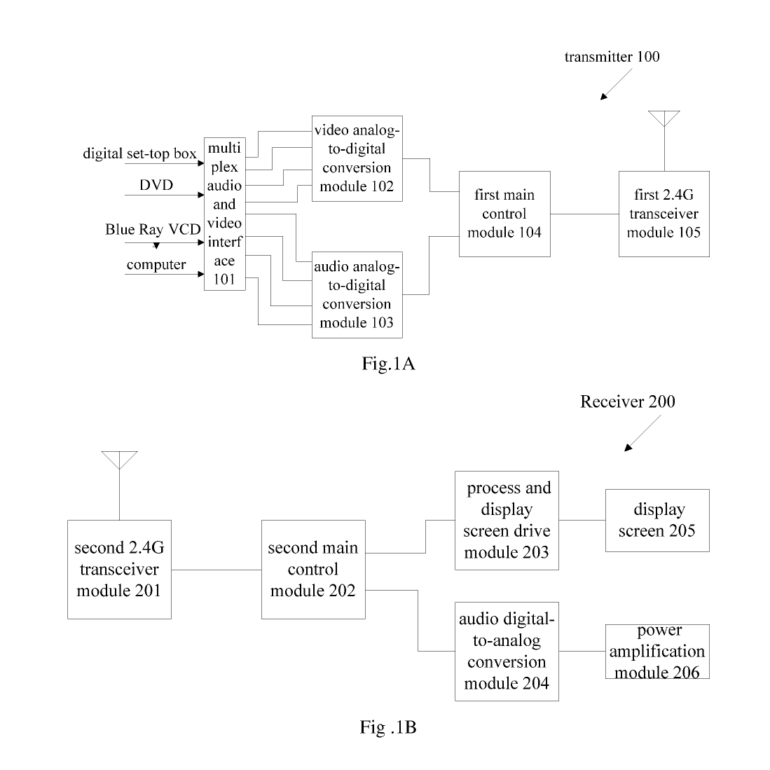

As shown in FIGS. 1A and 1B, in the first embodiment of the transmitter and receiver of the system for domestic multimedia playing according to present invention, the transmitter 100 comprises a multiplex audio and video interface 101, a video analog-to-digital conversion module 102, an audio analog-to-digital conversion module 103, a first main control module 104 and a first 2.4G transceiver module 105. The receiver 200 comprises a second 2.4G transceiver module 201, a second main control module 202, a process and display screen drive module 203, an audio digital-to-analog conversion module 204, a display screen 205, a power amplification module 206. Wherein, in the receiver 100, the multiplex audio and video interface 101 has four channels connected with four multimedia devices such as digital set-top box, DVD, Blue-Ray VCD, computer and so on. The multiplex audio and video interface 101 is operable to receive audio and video data outputted from the multimedia devices. The video analog-to-digital conversion module 102 such as four-channel video AD converter of Type 8861 is operable to analog-to-digital convert received video data. The audio analog-to-digital conversion module 103 such as audio AD converter of Type AK5357 is operable to analog-to-digital convert received audio data. The first main control module 104 such as DSP chip of Type 93500 is operable to encode and compress the analog-to-digital converted audio and video data. The first 2.4G transceiver module 105 is operable to transmit encoded and compressed audio and video data to the receiver 200. In the receiver 200, the second 2.4G transceiver module 201 is operable to receive audio and video data from the transmitter 100. The second main control module 202 is operable to decode and decompress the received audio and video data. The process and display screen drive module 203 is operable to digital-to-analog convert the decoded and decompressed video data and drive the display screen 205 to play the converted video. The audio digital-to-analog conversion module 204 is operable to digital-to-analog convert the decoded and decompressed audio data and drive the power amplification module 206 to play the converted audio.

When implementing the technical solution of present embodiment, the transmitter 100 is connected with the multimedia device, and fixed at one place in the home, then the receiver 200 receives the audio and video by a means of 2.4G radio frequency. In such a way, the user can carry the receiver 200 and watch multimedia program at any time and anywhere.

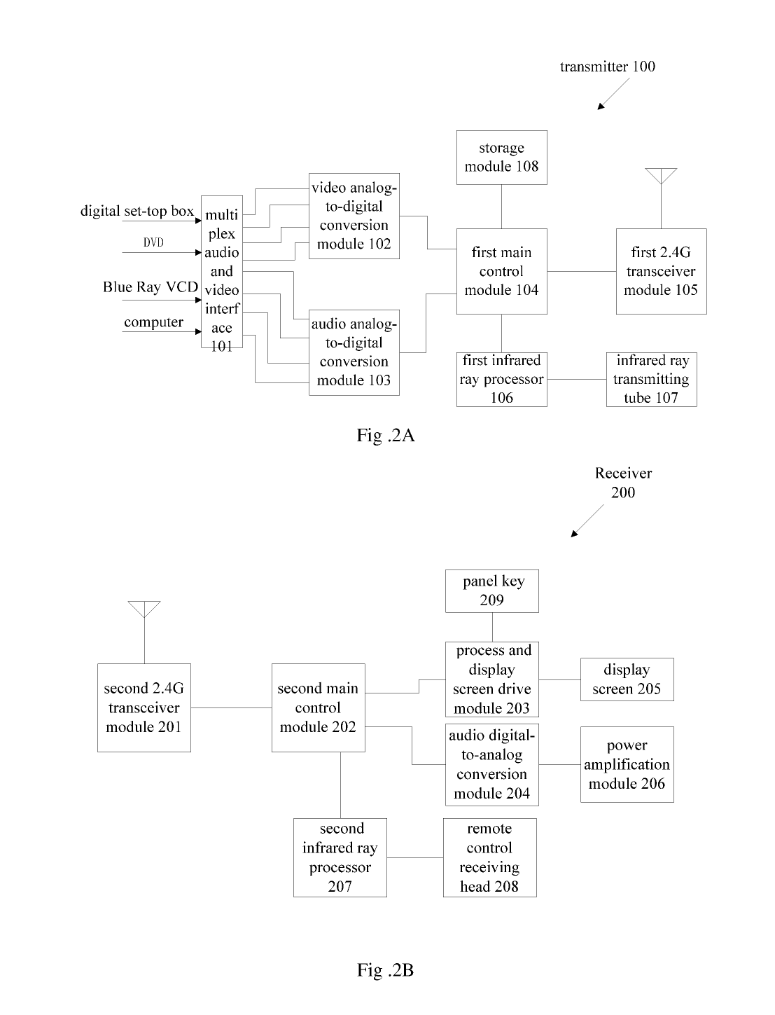

In the second embodiment of the transmitter and receiver of the system for domestic multimedia playing according to present invention as shown in FIGS. 2A and 2B, comparing with the transmitter in embodiment 1, the transmitter in present embodiment further comprises a first infrared ray processor 106, an infrared ray transmitting tube 107 and a storage module 108. Comparing with the receiver in embodiment 1, the receiver in present embodiment further comprises a second infrared ray processor 207, a remote control receiving head 208 and a panel key 209. The same parts in embodiments 1 and 2 are not described for conciseness. In additional, it should be explained that the system for domestic multimedia playing of present embodiment further comprises a remote controller (unshown) like the remote controller of the ordinary multimedia device. Following operations can be performed via the remote controller: switching the channels between a plurality of multimedia devices, selecting channel, tuning volume, searching programs, muting/canceling mute. When controlling the multimedia device by the remote controller, the remote controller should be configured to operate in a remote control mode, then the user presses the corresponding key on the remote controller, then the remote control receiving head 208 of the receiver 200 receives remote control signal sent out by the remote controller. The second infrared ray processor 207 is operable to identify received remote control signal and transform the received remote control signal to corresponding binary code. The second main control module 202 and the second infrared ray processor 207 are connected via a SPI bus. The second main control module 202 is further operable to encode and compress the binary code. The second 2.4G transceiver module 201 is operable to transmit the encoded and compressed binary code to the transmitter 100. Then the first 2.4G transceiver module 105 is operable to receive the binary code from the receiver 200. The first main controller 104 is operable to decompress and decode the received binary code. The first infrared ray processor 106 is operable to transform the decompressed and decoded binary code to remote control signal. The infrared ray transmitting tube 107 is operable to transmit the remote control signal to corresponding multimedia devices. In such a way, remote control of the multimedia device via the remote controller is achieved.

Now, the storage module 108 in the transmitter 100 is illustrated as follows. The remote controller in the multimedia playing system should control a plurality of multimedia devices, and the remote controllers of such multimedia devices are not universal. Accordingly, one remote controller code table for each multimedia device should be stored. The storage module 108 stores a plurality of remote controller code tables corresponding to a plurality of multimedia devices one by one, each remote controller code table corresponds to the type of one multimedia device. When using, only need to call the remote controller code table of the corresponding multimedia device. If the remote controller code table of a certain multimedia device has not been stored by the producer, only need to create a new remote controller code table corresponding to the multimedia device.

Before the connected multimedia device are remotely controlled by the remote controller, determine whether the remote controller code table corresponding to the connected multimedia device is stored, if yes, receive type of the connected multimedia device inputted by the user so as to match the keys of the remote controller and those of the multimedia device, then the connected multimedia device can be remotely controlled according to the above mentioned method. If no remote controller code table corresponding to the connected multimedia device is stored, the transmitter should be configured to operate in a study mode so as to study the keys of the remote controller. Now, how the multimedia study the key of the remote controller is illustrated as follows. Firstly, the remote controller receives a study signal of a key to be studied and transmits the study signals. The key to be studied can be selected by moving the cursor. The remote control receiving head 208 receives the study signal. The second infrared ray processor 207 is operable to transform the study signal to corresponding binary code. The second main control module 202 is operable to encode and compress the binary code. The second 2.4G transceiver module 201 is operable to transmit the encoded and compressed binary code to the transmitter. The first 2.4G transceiver module 105 is operable to receive the binary code from the transmitter. The first main control module 104 is operable to decompress and decode the received binary code, and receive a signal from a key pressed by the user on the multimedia device and corresponded to the key to be studied, and to write the decompressed and decoded binary code into a new created remote controller code table in the storage module. It should be noted that the key on the multimedia device can be a key on the remote controller of the multimedia device.

Now, the panel key 209 in the FIG. 2B is illustrated as follows. The panel key 209 is operable to receive input signal of the user. The process and display screen drive module 203 processes the received input signal. The second infrared ray processor 207 transforms the processed signal to corresponding binary code, and transmits the binary code to the second main control module 202. The binary code is the same as the binary code of the corresponding keys of the remote controller. As the input signal has the same key function as that of the remote controller. The following steps are the same as those for controlling the multimedia device by the remote controller, so are not described for conciseness.

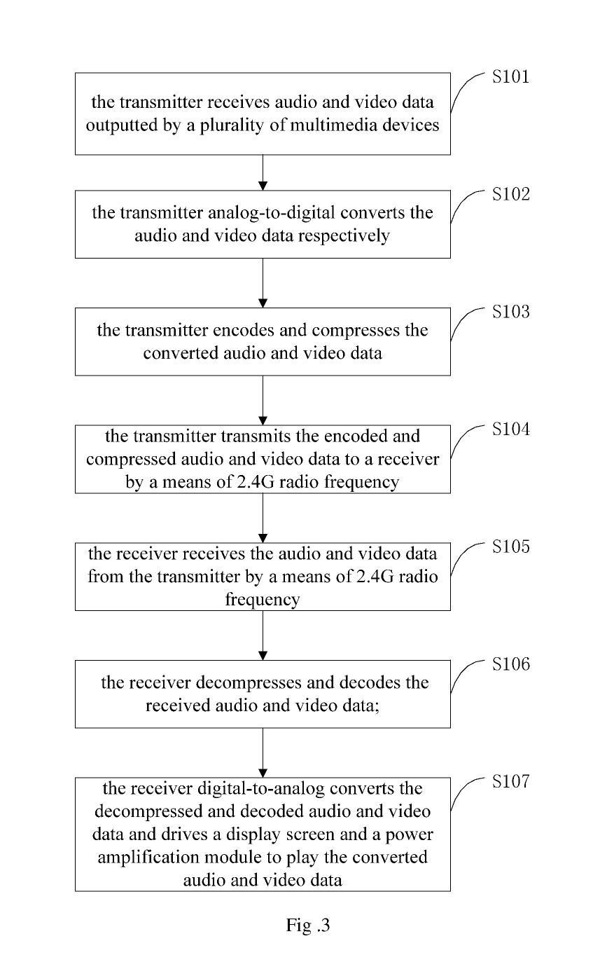

FIG. 3 is a flow chart of the first embodiment of the method for domestic multimedia playing according to present invention, the method for domestic multimedia playing comprises:

S101, the transmitter receives audio and video data outputted by a plurality of multimedia devices;

S102, the transmitter analog-to-digital converts the audio and video data respectively;

S103, the transmitter encodes and compresses the converted audio and video data;

S104, the transmitter transmits the encoded and compressed audio and video data to a receiver by a means of 2.4G radio frequency;

S105, the receiver receives the audio and video data from the transmitter by a means of 2.4G radio frequency;

S106, the receiver decompresses and decodes the received audio and video data;

S107, the receiver digital-to-analog converts the decompressed and decoded audio and video data and drives a display screen and a power amplification module to play the converted audio and video data.

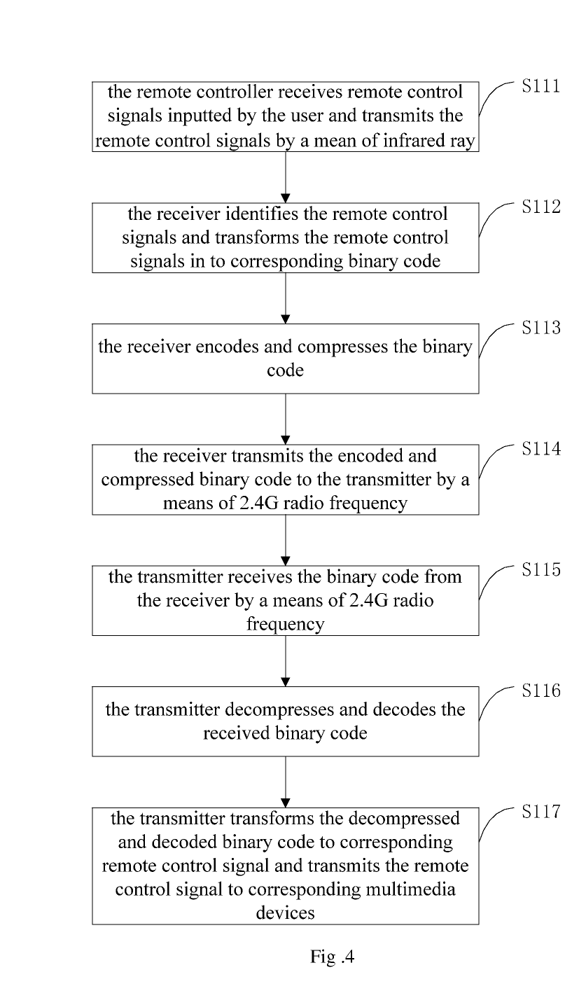

The remote controller has two work modes, one of which is the remote control mode, and the other is the study mode. Combining FIG. 4, when the remote controller operates in the remote control mode, the method for domestic multimedia playing further comprises:

S111, the remote controller receives remote control signals inputted by the user and transmits the remote control signals by a mean of infrared ray;

S112, the receiver identifies the remote control signals and transforms the remote control signals into corresponding binary code;

S113, the receiver encodes and compresses the binary code;

S114, the receiver transmits the encoded and compressed binary code to the transmitter by a means of 2.4G radio frequency;

S115, the transmitter receives the binary code from the receiver by a means of 2.4G radio frequency;

S116, the transmitter decompresses and decodes the received binary code;

S117, the transmitter transforms the decompressed and decoded binary code to corresponding remote control signal and transmits the remote control signal to corresponding multimedia devices.

Before the connected multimedia device are remotely controlled by the remote controller, determine whether the remote controller code table corresponding to the connected multimedia device is stored, if yes, receive type of the connected multimedia device inputted by the user so as to match the keys of the remote controller and those of the multimedia device. Or else, the transmitter should be configured to operate in a study mode so as to match the keys of the remote controller and those of the multimedia device.

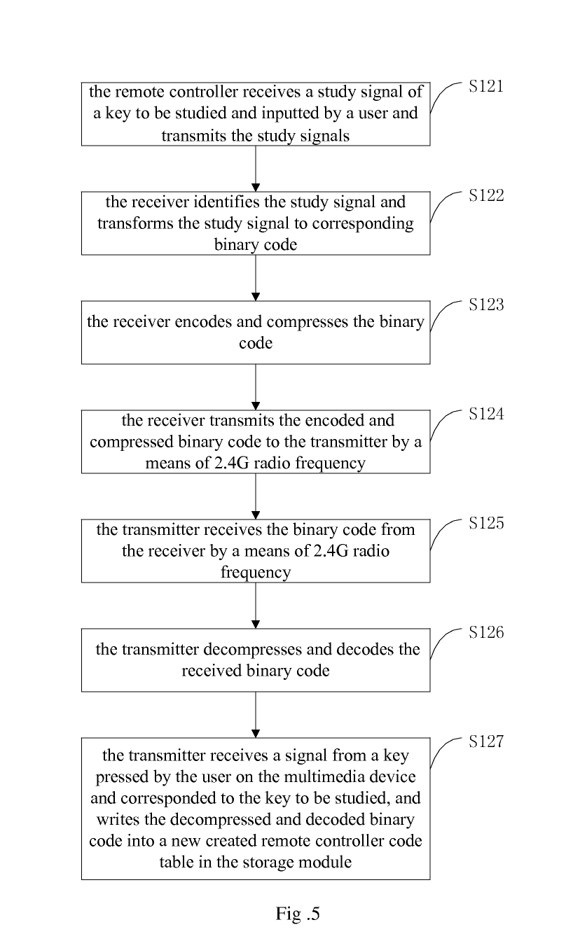

FIG. 5 is a flow chart of the third embodiment of the method for domestic multimedia playing when the remote controller operates in a study mode according to present invention. When the remote controller operates in a study mode, the method for domestic multimedia playing further comprises:

S121, the remote controller receives a study signal of a key to be studied and inputted by a user and transmits the study signals;

S122, the receiver identifies the study signal and transforms the study signal to corresponding binary code;

S123, the receiver encodes and compresses the binary code;

S124, the receiver transmits the encoded and compressed binary code to the transmitter by a means of 2.4G radio frequency;

S125, the transmitter receives the binary code from the receiver by a means of 2.4G radio frequency;

S126, the transmitter decompresses and decodes the received binary code;

S127, the transmitter receives a signal from a key pressed by the user on the multimedia device and corresponded to the key to be studied, and writes the decompressed and decoded binary code into a new created remote controller code table in the storage module.

The control process of the multimedia devices by the remote controller is illustrated above. However, in the method for domestic multimedia playing of present invention, besides employing the remote controller, the panel key on the receiver also can be used to control the multimedia devices. When controlling the multimedia devices by the panel key, the method for domestic multimedia playing further comprises:

the panel key of the receiver receives input signal of the user;

the receiver transforms the received input signal to corresponding binary code;

the receiver encodes and compresses the binary code;

the receiver transmits the encoded and compressed binary code to the transmitter by a means of 2.4G radio frequency;

the transmitter receives the binary code from the receiver by a means of 2.4 G radio frequency;

the transmitter decompresses and decodes the received binary code;

the transmitter transforms the decompressed and decoded binary code to corresponding remote control signal and transmits the remote control signal to corresponding multimedia device.

The foregoing description of the exemplary embodiments of the invention has been presented only for the purposes of illustration and description and is not intended to be exhaustive or to limit the invention to the precise forms disclosed. Any modifications and variations are possible in light of the above teaching without departing from the protection scope of the present invention.

1. A system for domestic multimedia playing, comprising a transmitter and a receiver, wherein,
the transmitter further comprises:
a multiplex audio and video interface coupled to a plurality of multimedia devices and operable to receive audio and video data outputted from the multimedia devices,
a video analog-to-digital conversion module operable to analog-to-digital convert received video data,
an audio analog-to-digital conversion module operable to analog-to-digital convert received audio data,
a first main control module operable to encode and compress the analog-to-digital converted audio and video data,
a first 2.4G transceiver module operable to transmit encoded and compressed audio and video data to the receiver;
the receiver further comprises:
a display screen,
a power amplification module,
a second 2.4G transceiver module operable to receive audio and video data from the transmitter,
a second main control module operable to decode and decompress the received audio and video data,
a process and display screen drive module operable to digital-to-analog convert the decoded and decompressed video data and drive the display screen to play the converted video;
an audio digital-to-analog conversion module operable to digital-to-analog convert the decoded and decompressed audio data and drive the power amplification module to play the converted audio.

2. The system for domestic multimedia playing according to claim 1, further comprising a remote controller, wherein;
the receiver further comprises a remote control receiving head and a second infrared ray processor, wherein;
the remote control receiving head is operable to receive remote control signal sent from the remote controller;
the second infrared ray processor is operable to identify received remote control signal and transform the received remote control signal to corresponding binary code;
the second main control module is further operable to encode and compress the binary code;
the second 2.4G transceiver module is operable to transmit the encoded and compressed binary code to the transmitter;
the transmitter further comprises a first infrared ray processor and a infrared ray transmitting tube, and
the first 2.4G transceiver module is further operable to receive binary code from the receiver;
the first main controller is operable to decompress and decode the received binary code;
the first infrared ray processor is operable to transform the decompressed and decoded binary code to remote control signal;
the infrared ray transmitting tube is operable to transmit the remote control signal to corresponding multimedia devices.

3. The system for domestic multimedia playing according to claim 2, wherein, the receiver comprises a panel key operable to receive input signals of the user; and
the process and display screen drive module is further operable to process the input signal;
the second infrared ray processor is further operable to transform the processed input signal to corresponding binary code, and transmit the binary code to the second main control module, the binary code is the same as the binary code corresponding to the corresponding key of the remote controller.

4. The system for domestic multimedia playing according to claim 1, wherein, the transmitter further comprises:
a storage module operable to store a plurality of remote controller code tables corresponding to the plurality of multimedia devices, and each remote controller code table is corresponding to type of one multimedia device.

5. The system for domestic multimedia playing according to claim 4, wherein, when operating in a study mode, the remote controller is operable to receive a study signal of a key to be studied and transmit the study signals;
the remote control receiving head is further operable to receive the study signal;
the second infrared ray processor is operable to transform the study signal to corresponding binary code;
the second main control module is operable to encode and compress the binary code;
the second 2.4G transceiver module is operable to transmit the encoded and compressed binary code to the transmitter;
the first 2.4G transceiver module is operable to receive the binary code from the transmitter;
the first main control module is operable to decompress and decode the received binary code, and receive a signal from a key pressed by the user on the multimedia device and corresponded to the key to be studied, and to write the decompressed and decoded binary code into a new created remote controller code table in the storage module.

6. A method for domestic multimedia playing, comprising:
receiving audio and video data outputted by a plurality of multimedia devices by a transmitter;
analog-to-digital converting the audio and video data respectively by the transmitter;
encoding and compressing the converted audio and video data by the transmitter;
transmitting the encoded and compressed audio and video data to a receiver by a means of 2.4G radio frequency by the transmitter;
receiving the audio and video data from the transmitter by a means of 2.4G radio frequency by the receiver;
decompressing and decoding the received audio and video data by the receiver;
digital-to-analog converting the decompressed and decoded audio and video data and driving a display screen and a power amplification module to play the converted audio and video data by the receiver.

7. The method for domestic multimedia playing according to claim 6, wherein, when the remote controller operates in a remote control mode, the method for domestic multimedia playing further comprises:
receiving remote control signals inputted by the user and transmitting the remote control signals by a mean of infrared ray by the remote controller;
identifying the remote control signals and transforming the remote control signals into corresponding binary code by the receiver;
encoding and compressing the binary code by the receiver;
transmitting the encoded and compressed binary code to the transmitter by a means of 2.4G radio frequency by the receiver;
receiving the binary code from the receiver by a means of 2.4G radio frequency by the transmitter;
decompressing and decoding the received binary code by the transmitter;
transforming the decompressed and decoded binary code to corresponding remote control signal and transmitting the remote control signal to corresponding multimedia devices by the transmitter.

8. The method for domestic multimedia playing according to claim 7, wherein, when the remote controller operates in a study mode, the method for domestic multimedia playing further comprises:
receiving a study signal of a key to be studied and inputted by a user and transmitting the study signals by a means of infrared ray by the remote controller;
identifying the study signal and transforming the study signal to corresponding binary code by the receiver;
encoding and compressing the binary code by the receiver;
transmitting the encoded and compressed binary code to the transmitter by a means of 2.4G radio frequency by the receiver;
receiving the binary code from the receiver by a means of 2.4G radio frequency by the transmitter;
decompressing and decoding the received binary code by the transmitter;
receiving a signal from a key pressed by the user on the multimedia device and corresponded to the key to be studied, and writing the decompressed and decoded binary code into a new created remote controller code table by the transmitter.

9. The method for domestic multimedia playing according to claim 8, wherein, when remote controlling the multimedia devices by using the remote controller, the method for domestic multimedia playing further comprises:
determining whether the remote controller code table of the connected multimedia device is stored by the transmitter, if yes, receiving type of the connected multimedia device inputted by the user by the transmitter so as to match the keys of the remote controller and those of the multimedia device, or else, the transmitter operating in a study mode so as to match the keys of the remote controller and those of the multimedia device.

10. The method for domestic multimedia playing according to claim 6, wherein, further comprising:
receiving input signal of the user by the panel key of the receiver;
transforming the received input signal to corresponding binary code by the receiver, the binary code is the same as the binary code corresponding to the corresponding key of the remote controller;
encoding and compressing the binary code by the receiver;
transmitting the encoded and compressed binary code to the transmitter by a means of 2.4G radio frequency by the receiver;
receiving the binary code from the receiver by a means of 2.4 G radio frequency by the transmitter;
decompressing and decoding the received binary code by the transmitter;
transforming the decompressed and decoded binary code to corresponding remote control signal and transmitting the remote control signal to corresponding multimedia device by the transmitter.
